(19) United States
(12) Patent Application Publication
(10) Pub. No.: US 2014/0279438 A1
(43) Pub. Date: Sep. 18, 2014

(54) BRIDGING SUSPENSION OF ACCOUNTS

(71) Applicants: Michael Reiff, Austin, TX (US); Anh Vazquez, San Mateo, CA (US); Wade Weisser, Austin, TX (US)

(72) Inventors: Michael Reiff, Austin, TX (US); Anh Vazquez, San Mateo, CA (US); Wade Weisser, Austin, TX (US)

(21) Appl. No.: 14/206,702

(22) Filed: Mar. 12, 2014

Related U.S. Application Data
(60) Provisional application No. 61/783,982, filed on Mar. 14, 2013.

(51) Int. Cl. G06Q 20/34; G06Q 20/28

(52) U.S. Cl. CPC G06Q 20/354; G06Q 20/28
USPC 705/39

(57) ABSTRACT

A method for servicing accounts includes receiving a determination from a service provider system indicating cancellation of a service account from the service provider system, deducting a balance from a prepaid card account as a result of the determination indicating cancellation of the service account, and sending the balance to the service provider system.

### RELATED APPLICATION

This application claims the benefit under 35 U.S.C. §119(e) of U.S. Provisional Application No. 61/783,982 filed Mar. 14, 2013 and entitled “Bridging Suspension of Accounts.”

### TECHNICAL FIELD OF THE INVENTION

The present invention relates generally payment systems and, more particularly, to bridging suspension of accounts.

### BACKGROUND

Cash may refer to the physical or electronic possession of government-backed or legal tender currency such as in the form of dollar bills, reserve notes, coins, checking accounts, or saving accounts. The electronic transfer of cash from an entity, such as an individual or business, to another entity facilitates payments, commerce, and interpersonal transactions in situations such as person to person, in-person retail, points-of-sale, and online transactions. Debits may form another manner of transferring cash between entities.

### SUMMARY

In one embodiment, a method for servicing accounts includes receiving a determination from a service provider system indicating cancellation of a service account from the service provider system, deducting a balance from a prepaid card account as a result of the determination indicating cancellation of the service account, and sending the balance to the service provider system.

In another embodiment, an article of manufacture includes instructions on a non-transitory, computer-readable medium. The instructions, when loaded and executed by a processor, cause processor to receive a determination from a service provider system indicating cancellation of a service account from the service provider system, deduct a balance from a prepaid card account as a result of the determination indicating cancellation of the service account, and send the balance to the service provider system.

In yet another embodiment, a system includes a processor, a memory communicatively coupled to the processor, and a prepaid card server comprising instructions resident in the memory for execution on the processor. The instructions are read and executed by the processor, configure the prepaid card server to receive a determination from a service provider system indicating cancellation of a service account from the service provider system, deduct a balance from a prepaid card account as a result of the determination indicating cancellation of the service account, and send the balance to the service provider system.

### BRIEF DESCRIPTION OF DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is an illustration of an example embodiment of a system for bridging suspension of accounts;

FIG. 2 is an illustration of example operation and further configuration of a system for bridging suspension of accounts; and

FIG. 3 is an illustration of an example embodiment of a method for bridging suspension of accounts.

### DETAILED DESCRIPTION

FIG. 1 is an illustration of an example embodiment of a system 100 for bridging suspension of accounts. Such accounts may include accounts associated with a service provider. The service provider may be a provider of any suitable goods or services to various users. The service provider may use one or more servers, networks, applications, interfaces, scripts, modules, executables, databases, cloud computing, software, software-as-a-service, or other entities to provide management, billing, and other account services. For example, a service provider may utilize a service provider system 102. Although a single service provider system is illustrated in FIG. 1, service provider system 102 may include any suitable number, kind, and combination of elements for providing account services. Service provider system 102 may include or be communicatively coupled to service account information 112, which may be implemented in a database, server, applications, cloud computing scheme, software, software-as-a-service, or other suitable mechanisms. Service account information 112 may store information about accounts for users for service provider system 102. Such a user of service provider system 102 may include a user with user electronic device 106. The user may be identified by a suitable identification, such as identifier 116. Service account information 112 may provide reports, applications, interfaces, functions, or other mechanisms for service provider system 102 to, on-demand or periodically, provide information about the accounts included therein.

A prepaid card system 104 is illustrated in FIG. 1. However, any suitable financial or similar institution may be used instead of prepaid card system 104, which is provided as an example. Furthermore, although a system for a prepaid card is described, a system including provisions for debit, demand-deposit, checking, credit, savings, or other financial accounts may be used. Prepaid card system 104 may use one or more servers, networks, applications, interfaces, scripts, modules, executables, databases, cloud computing, software, software-as-a-service, or other entities to provide financial or debit card services. Although a single prepaid card system is illustrated, prepaid card system 104 may include any suitable number, kind, and combination of elements for providing account services. Prepaid card system 104 may include or be communicatively coupled to prepaid account information 114, which may be implemented in a database, server, applications, cloud computing scheme, software, software-as-a-service, or other suitable mechanisms. Prepaid account information 114 may store information about accounts for users of prepaid card system 104. Prepaid account information 114 may provide reports, applications, interfaces, functions, or other mechanisms for prepaid card system 104 to, on-demand or periodically, provide information about the accounts included therein.

Each of service provider system 102 and prepaid card system 104 may include one or more processors 122, 124 communicatively coupled to one or more respective memories 126, 128 for performing the operation and configuration as described. Applications, modules, scripts, executables, libraries, executables, object code, logic, software, code, or instructions may be used to implement one or more portions of service provider system 102 or prepaid card system 104. These may include instructions carried on respective memories 126, 128 for execution by respective processors 122, 124. The execution of such entities may cause the configuration, functionality, and operation of service provider system 102 and prepaid card system 104 as described.

Processors 122, 124 may comprise, for example a microprocessor, microcontroller, digital signal processor (DSP), application specific integrated circuit (ASIC), or any other digital or analog circuitry configured to interpret and/or execute program instructions and/or process data. In some embodiments, processors 122, 124 may interpret and/or execute program instructions and/or process data stored in memories. Memories 126, 128 may be configured in part or whole as application memory, system memory, or both. Memories 126, 128 may include any system, device, or apparatus configured to hold and/or house one or more memory modules. Each memory module may include any system, device or apparatus configured to retain program instructions and/or data for a period of time (e.g., computer-readable media). The various servers, electronic devices, or other machines described may contain one or more similar such processors or memories for storing and executing program instructions for carrying out the functionality of the associated machine.

A user may include any suitable electronic device or interface for interacting with service provider system 102 or prepaid card system 104. The user may use, for example, a computer, tablet, smartphone, mobile device, server, laptop, module, application, webpage, text message, or other mechanism for such interactions. Such mechanisms may be wholly or partially embodied in a memory for execution by a processor. User electronic device 106, as shown in FIG. 1, may include such mechanisms for operation.

The user may have an account 120 with prepaid card system 104. Prepaid card system account 120 may be identified by any suitable mechanism, such as account number, username, the user's social security number or driver's license number, address, or other information. Prepaid card system account 120 may include a balance of cash, available funds, or other monetary value. Furthermore, prepaid card system account 120 may include a set of attributes or preferences. Such information may be stored in any suitable manner, such as by a relational database in prepaid account information 114.

The user may have an account 130 with service provider system 102. The service provider account may be identified by any suitable mechanism, such as account number, username, the user's social security number or driver's license number, address, or other information. The service provider account may include a number of attributes or preferences. Such information may be stored in any suitable manner, such as by a relational database in service account information.

Service provider system 102 may include a system for providing or managing the providing of any suitable goods and services, such as but not limited to: mobile or telephonic communications; utilities; electricity; water; gas; television or video; video-on-demand; television recording; networking; Internet service; web applications; software-as-a-service; cloud computing; data storage; banking or financial services; anti-malware; computer security; website access; information service; online gaming; organization membership; career services; social networking; matchmaking; market or business information; information technology management; or videoconferencing. The goods or service may include such goods or services that cause recurring fees or charges.

Nonpayment for such a service may incur a stoppage in the providing of such services. In one embodiment, certain types, amounts, or duration of nonpayment may incur service provider system 102 to cancel, eliminate, or terminate an associated account. In another embodiment, inactivity with respect to an account may incur service provider system 102 to eliminate or terminate an associated account. Such cancellation, elimination, or termination of an associated account may differ from mere stoppage of the service or prevention of access to the service. System 100 may be configured to bridge, abrogate, pause, prevent, or otherwise handle such a possible elimination or termination of an account of service provider system 102. Such handling may be considered “bridging” of service provider accounts such that the accounts are preserved. Service provider system 102, prepaid card system 104, or a combination of both may be configured to work to automatically or on-demand service an account of service provider system 102 to handle a possible elimination or termination of an account of service provider system 102.

System 100 may be configured to handle a possible elimination or termination of an account, such as user's account 130, of service provider system 102 wherein such an elimination or termination of the account may effect or represent a loss to a user with greater or different significance or value than mere inaccessibility of the service, or greater or different significance or value than a mere fee. For example, a mobile telephone account created in a pay-as-you-go account model may be deactivated upon non-payment of scheduled fees, a period of inactivity, or other criteria. With a zero or negative balance on the mobile telephone account, a user of the mobile telephone service may be unable to use the mobile telephone service. However, in one embodiment, with a zero or negative balance on the mobile telephone account for a certain time period, or with inactivity of the mobile telephone account for a certain time period, the mobile account itself may be terminated or eliminated. In a further embodiment, an effect upon the user is that the user may permanently lose use of identifiers—such as phone numbers, usernames, handles, screen names, or user profiles—upon which the user relies. Such identifiers may be transferred to other users. For example, user may utilize identifier 116 in user electronic device 106 for use with service provider system 102. After termination of account 130, identifier 116 might not be usable with user electronic device 106. In another, further embodiment, an effect upon the user is that the user may lose unused minutes, application store balance, unused data usage balance, unused text messages, or other balances in account 130 upon which the user relies. In yet another, further embodiment, an effect upon the user is that the user may lose stored phone numbers, stored text messages, stored applications, or other content that was associated with identifier 116 or account 130.

Service provider system 102, prepaid card system 104, or a combination of both may be configured to fund service provider account 130 with prepaid card account 120 in order to prevent suspension of service provider account 130. Furthermore, in some embodiments service provider system 102, prepaid card system 104, or a combination of both may be configured to fund service provider account 130 with prepaid card account 120 in order to prevent deactivation or termination of service provider account 120. Such a funding may be considered an account activity in service account information 112 that may prevent deactivation or termination of service provider account 130.

In order to fund service provider account 130 with prepaid card account 120, information may be shared between service provider system 102, prepaid card system 104, and user electronic device 106. Any suitable kind of information may be shared. Sharing of information between the entities of system 100 may be conformed to applicable laws and regulations regarding privacy and sharing of information.

For example, at (1A) a user with user electronic device 106 and having prepaid card account 120 may select one or more opt-in choices for account bridging services of prepaid card system 104. Such an opt-in may designate that prepaid card account 120 in prepaid card system 104 may be available, for example, for bridging from any possible service provider or a designated selection of service providers. For example, service provider system 102 may be designated. The opt-in may designate that bridging may happen, for example, automatically, or that bridging may be presented to the user as an option when it is available or needed. Multiple choices may be available for combinations of such an opt-in. The user may provide identifier 116 to prepaid card system 110 by which service provider system 102 may recognize service account 130 of the user. A user may later opt-out of any of such choices.

In another example, at (1B) the user with user electronic device 106 may inform service provider system 102 about the user's prepaid card account 120. Service provider system 102 may inquire about bridging services to prepaid card system 104 when needed. An identifier by which service provider system 102 will make such an inquiry, such as an identifier of prepaid card account 120, may be provided.

At (2), service provider system 102 and prepaid card system 104 may exchange information about accounts of the respective systems that are available for bridging services. Such an exchange may be made prospectively or on-demand upon a determination that a service provider account may be suspended or cancelled, terminated, or eliminated.

FIG. 2 illustrates example operation and further configuration of system 100 to provide bridging service. At (3), service provider system 102 may conduct a billing cycle or account service activity. At (4), such activities may include evaluating one or more user service accounts to determine whether any such accounts are to be suspended due to a lack of payment, overdraft, negative balance, or inactivity. Furthermore, such activities may include evaluating such accounts to determine whether any are to be eliminated, cancelled, or terminated due to a lack of payment, overdraft, negative balance, or inactivity. The thresholds for each such action may vary according to degree or time.

Service provider system 102—or prepaid card holder, upon notification of service account balances or inactivity—may apply decision-making, rules 108, 110, thresholds, or other automated mechanisms for determining whether to notify a user of the impending action or to determine whether to conduct bridging services to prevent impending action. The specific rules, thresholds, or other criteria may depend upon the type of service provided and the effect of the impending action. Any suitable forms of such triggers for bridging services may be applied. For example, suspension of a mobile phone service for nonpayment may occur after thirty days of nonpayment on a negative balance. Such a suspension may be used as a threshold for applying bridging service. In one embodiment, cancellation, termination, or elimination of a user account, such as a mobile phone service telephone number, may be applied after ninety days of nonpayment on a negative balance or ninety days of inactivity. Such actions may be used as a threshold for applying bridging service. At (5), a user may be billed if the thresholds are not exceeded. The billing may be made through prepaid card system 104.

At (6), service provider system 102 may contact prepaid card system 104 that user account 130 is past due or is inactive. In one embodiment, service provider system 102 may inform prepaid card system 104 that suspension or cancellation, termination, or elimination of user service account 130 will be performed. In another embodiment, prepaid card system 104 may determine that suspension or cancellation, termination, or elimination of user account 130 will be performed. In such an embodiment, prepaid card system 104 may proactively monitor the user's service account 130, even though the account is resident on service provider system 102.

In one embodiment, service provider system 102 may message prepaid card system 104 to determine whether a user has reached a threshold of, for example, suspension or cancellation, termination, or elimination as set by the user's choices of options with account 120. In another embodiment, service provider system 102 may message prepaid card system 104 to inform prepaid card system 104 that such thresholds have been met.

In some cases, service provider system 102 may define whether a partial or full payment is necessary to prevent the suspension or the cancellation, termination, or elimination of a user account. In other cases, prepaid card system 104 may determine from user preferences or user communication in account 120 whether a full or partial payment is to be made. Furthermore, amounts may be defined to distinguish between a) prevention of cancellation, termination, or elimination of a user account, and b) prevention of suspension (or reinstatement) of services themselves.

Upon determination of a pending or possible suspension or cancellation, termination, or elimination of an account, service provider system 102 may use prepaid card system 104 to bill the user.

At (7), upon determination of a pending or possible suspension or cancellation, termination, or elimination of an account, prepaid card system 104 may determine whether account 120 is eligible for bridging services. Such determinations may include, for example: determining whether a user has opted-in for such services, whether automatically or with one-time-use authorization inquiries; inquiring to the user (via, for example, instant message, e-mail, or text message) whether the one-time bridging authorization is given; or determining whether the user has sufficient funds in prepaid card system 104 to cover an expected payment. In some cases, no account may be available, and prepaid card system 104 may simply check for such capabilities on behalf of service provider system 102 and thusly inform service provider system 102. Wherein a user is to be notified for one-time authorizations of bridging service, information may be transmitted indicating the specific aspect of account 130, such as the service itself, or the account username, phone number, or other content that will be eliminated.

If prepaid card system 104 determines that the user account is not eligible, not authorized, or contains insufficient funds, then at (8) and (9) prepaid card system 104 may notify the user and service provider system 102. The user may be informed on how to take additional steps to settle a bill for service provider system 102. Service provider system 102 may take the intended action upon notification from prepaid card system 104.

If prepaid card system 104 determines that user account 120 is eligible, is authorized, and contains sufficient funds, then at (8) a payment may be initiated from the user's prepaid card account 120 to service provider system 102. The payment may identify service provider account 130 to which the funds should be applied. Furthermore, the payment may identify whether it is to preserve or restore service itself, or whether it is to prevent elimination, termination, or cancellation of the account. At (9), the user may be notified about the transaction.

The user may be charged fees as applicable for the bridging service. The user may be notified of a grace period in which fees may or may not apply. In one embodiment, the user may be charged fees if the user prepaid card account reaches a negative balance as a result of the fee. Prepaid card system 104 may be remitted a fee from service provider system 102 for handling the payment process. Furthermore, the payment may act as a float, through which a fee is applied only if prepaid card account 130 is negative as a result of the payment. Prepaid card system 104 may be configured to grant user account 120 a grace period in which such a negative balance due to bridging activity may be brought to a positive or zero balance without incurring a fee.

At (10), service provider system 102 may receive the payment and maintain the service or halt operations to eliminate, cancel, or terminate the account. Even though an account may remain valid as a result of maintaining the account, service may not be available.

FIG. 3 may illustrate method 200 of providing bridging service between a service provider system and a prepaid card system 104, such as service provider system 102 and prepaid card system 104.

At 305, a billing cycle of service provider system 102 may be executed, wherein inactive or over-balance accounts are examined. Such activities may include evaluating one or more user service accounts to determine whether any such accounts are to be suspended due to a lack of payment, overdraft, negative balance, or inactivity. Furthermore, such activities may include evaluating such accounts to determine whether any are to be eliminated, cancelled, or terminated due to a lack of payment, overdraft, negative balance, or inactivity. The thresholds for each such action may vary according to degree or time. At 310, it may be determined that a given service account is to be deactivated, eliminated, cancelled, or terminated.

At 315, the service account may be identified to prepaid card system 102. In one embodiment, prepaid card system 104 may initiate a query to service provider system 102. In a further embodiment, such a query may further cause performance of 305 and 310. In another embodiment, service provider system 102 may initiate contact with prepaid card system 104 after performing 305 and 310. The service, the service account, amounts to prevent elimination of the service account, and amounts to reinstate service itself may be identified. An identifier of the user may be used, such as an account of prepaid card system 104, an account of service provider system 102, or an independent identifier.

At 320, prepaid card system 104 prepaid card system 104 or service provider system 102 may determine whether the user of the service account has a prepaid card account. If so, method 300 may proceed to 325. If not, method 300 may proceed to 385.

At 325, prepaid card system 104 or service provider system 102 may determine whether the user has opted-in for bridging service. If so, method 300 may proceed to 330. Otherwise, method 300 may proceed to 385.

At 330, prepaid card system 104 or service provider system 102 may determine whether the type of bridging needed has been authorized. For example, a user may have set preferences to allow bridging to preserve an account but not to keep active service. If the type of bridging needed has been authorized, method 300 may proceed to 335. Otherwise, method 300 may proceed to 385.

At 335, it may be determined by prepaid card system 104 may determine whether the user's prepaid account includes sufficient funds for the needed bridging action. If sufficient funds exist, method 300 may proceed to 350. Otherwise, method 300 may proceed to 340.

At 340, prepaid card system 104 may determine whether an overdraft is permitted. Such an overdraft may be made solely for the purposes of the requested bridging, as opposed to any other overdraft request. If overdraft is allowed, method 300 may proceed to 350. If overdraft is not allowed, method 300 may proceed to 385.

At 350, bridging may be allowed. Prepaid card system 104 may determine from user preferences, the prepaid card balance, and service provider system 102 what kind of payment is to be made. If a payment to preserve the account so that it is not eliminated, method 300 may proceed to 365. If a payment to further reinstate service is to be made, method 300 may proceed to 375.

At 365, payment for preserving the account may be made from prepaid card system 104 to service provider system 102. The amount of the payment may be deducted from the user's prepaid card account. The user may be notified about the transaction. At 370, the account may be preserved by service provider system 102.

At 375, payment for further restoring service associated with the account may be made from prepaid card system 104 to service provider system 102. The amount of the payment may be deducted from the user's prepaid card account. The user may be notified about the transaction. At 380, the account may be preserved by service provider system 102.

At 385, the bridging service may be denied. The user may be notified. At 390, service provider system 102 may terminate the account.

Method 300 may be implemented using the system of FIGS. 1-2, or any other suitable system. The preferred initialization point for such methods and the order of their steps may depend on the implementation chosen. In some embodiments, some steps may be optionally omitted, repeated, or combined. In some embodiments, some steps of such methods may be executed in parallel with other steps. In certain embodiments, the methods may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing. Although the present disclosure has been described in detail, it should be understood that various changes, substitutions, and alterations can be made hereto without departing from the spirit and the scope of the disclosure as defined by the appended claims.

What is claimed is:

1. A method for servicing accounts, comprising:
receiving a determination from a service provider system indicating cancellation of a service account from the service provider system;
deducting a balance from a prepaid card account as a result of the determination indicating cancellation of the service account; and
sending the balance to the service provider system.

2. The method of claim 1, wherein the determination from a service provider system indicating cancellation of the service account includes an identification of inactivity.

3. The method of claim 1, further comprising determining whether a user of the prepaid card account entered settings allowing automatically deducting the balance from the prepaid card account, wherein the settings are specific to the determination indicating cancellation of the service account.

4. The method of claim 1, further comprising:
receiving an additional determination from the service provider system indicating another balance required to restore service for the service account;
deducting the additional balance from the prepaid card account as a result of the determination indicating the other balance required to restore service for the service account; and
sending the other balance to the service provider system.

5. The method of claim 1, further comprising:
receiving an additional determination from the service provider system indicating another balance required to restore service for the service account;
determining whether a user of the prepaid card account entered first settings allowing automatically deducting the balance from the prepaid card account, wherein the settings are specific to the determination indicating cancellation of the service account;
determining whether the user of the prepaid card account entered second settings allowing automatically deducting the additional balance from the prepaid card account, wherein the second settings are specific to the determination indicating restoration of service to the service account; and
denying deduction of the additional balance from the prepaid card account.

6. The method of claim 1, further comprising:
determining that prepaid card account includes insufficient funds to fully fund the balance to be deducted resulting from the determination indicating cancellation of the service account; and
allowing overdraft of the prepaid card account based upon identification of preventing cancellation of the service account as the purpose of funding the balance.

7. An article of manufacture comprising instructions on a non-transitory, computer-readable medium, the instructions, when loaded and executed by a processor, for causing the processor to:
receive a determination from a service provider system indicating cancellation of a service account from the service provider system;
deduct a balance from a prepaid card account as a result of the determination indicating cancellation of the service account; and
send the balance to the service provider system.

8. The article of claim 7, wherein the determination from a service provider system indicating cancellation of the service account includes an identification of inactivity.

9. The article of claim 7, wherein the processor is further caused to determine whether a user of the prepaid card account entered settings allowing automatically deducting the balance from the prepaid card account, wherein the settings are specific to the determination indicating cancellation of the service account.

10. The article of claim 7, wherein the processor is further caused to:
receive an additional determination from the service provider system indicating another balance required to restore service for the service account;
deduct the additional balance from the prepaid card account as a result of the determination indicating the other balance required to restore service for the service account; and
send the other balance to the service provider system.

11. The article of claim 7, wherein the processor is further caused to:
receive an additional determination from the service provider system indicating another balance required to restore service for the service account;
determine whether a user of the prepaid card account entered first settings allowing automatically deducting the balance from the prepaid card account, wherein the settings are specific to the determination indicating cancellation of the service account;
determine whether the user of the prepaid card account entered second settings allowing automatically deducting the additional balance from the prepaid card account, wherein the second settings are specific to the determination indicating restoration of service to the service account; and
deny deduction of the additional balance from the prepaid card account.

12. The article of claim 7, wherein the processor is further caused to:
determine that prepaid card account includes insufficient funds to fully fund the balance to be deducted resulting from the determination indicating cancellation of the service account; and
allow overdraft of the prepaid card account based upon identification of preventing cancellation of the service account as the purpose of funding the balance.

13. A system, comprising:
a processor;
a memory communicatively coupled to the processor;
a prepaid card server comprising instructions resident in the memory for execution on the processor, the instructions, when read and executed, configure the prepaid card server to:
receive a determination from a service provider system indicating cancellation of a service account from the service provider system;
deduct a balance from a prepaid card account as a result of the determination indicating cancellation of the service account; and
send the balance to the service provider system.

14. The system of claim 13, wherein the determination from a service provider system indicating cancellation of the service account includes an identification of inactivity.

15. The system of claim 13, wherein the prepaid card server is further configured to determine whether a user of the prepaid card account entered settings allowing automatically deducting the balance from the prepaid card account, wherein the settings are specific to the determination indicating cancellation of the service account.

16. The system of claim 13, wherein the prepaid card server is further configured to:
receive an additional determination from the service provider system indicating another balance required to restore service for the service account;
deduct the additional balance from the prepaid card account as a result of the determination indicating the other balance required to restore service for the service account; and
send the other balance to the service provider system.

17. The system of claim 13, wherein the prepaid card server is further configured to:
receive an additional determination from the service provider system indicating another balance required to restore service for the service account;
determine whether a user of the prepaid card account entered first settings allowing automatically deducting the balance from the prepaid card account, wherein the settings are specific to the determination indicating cancellation of the service account;
determine whether the user of the prepaid card account entered second settings allowing automatically deducting the additional balance from the prepaid card account, wherein the second settings are specific to the determination indicating restoration of service to the service account; and
deny deduction of the additional balance from the prepaid card account.

18. The system of claim 13, wherein the prepaid card server is further configured to:
determine that prepaid card account includes insufficient funds to fully fund the balance to be deducted resulting from the determination indicating cancellation of the service account; and
allow overdraft of the prepaid card account based upon identification of preventing cancellation of the service account as the purpose of funding the balance.
